(19) United States
(12) Patent Application Publication
(10) Pub. No.: US 2010/0225861 A1
(43) Pub. Date: Sep. 9, 2010

(54) LIQUID CRYSTAL DISPLAY PANEL AND LIQUID CRYSTAL DISPLAY DEVICE

(76) Inventors: Koki Hongo, Osaka (JP); Kazuyoshi Fujioka, Osaka (JP); Tomoo Furukawa, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/600,170

(22) PCT Filed: Feb. 13, 2008
(86) PCT No.: PCT/JP2008/052361

§ 371 Date: Nov. 13, 2009

(30) Foreign Application Priority Data
Jun. 27, 2007 (JP) 2007-169650

(51) Int. Cl. G02F 1/1335

(52) U.S. Cl. 349/113

(57) ABSTRACT

A liquid crystal display panel (1) having a transmissive display region and a reflective display region, in which liquid crystal display panel (1) a pixel (PIXji) has a transmissive display region (21) having a substantially rectangular shape when viewed in a direction orthogonal to a panel plane, includes a protrusion (51) formed at and entirely along at least one edge of the reflective display region, the protrusion (51) having a projecting-line shape whose width is in a direction orthogonal to that edge of the reflective display region in the panel plane at and along which the protrusion is provided, and the protrusion (51) protruding into a liquid crystal layer in a layer thickness direction of the liquid crystal layer. This realizes a liquid crystal display panel having the transmissive display region and the reflective display region, in which liquid crystal display panel (i) an alignment regulating protrusion for driving a liquid crystal in a vertical alignment mode is included, and (ii) a response characteristic of reflective display can be made closer to that of transmissive display.

### TECHNICAL FIELD

The present invention relates to a liquid crystal display panel capable of performing display in both a transmissive mode and a reflective mode, in which liquid crystal display panel a liquid crystal molecule is driven in a vertical alignment mode wherein the liquid crystal molecule is vertically aligned when no voltage is applied.

### BACKGROUND ART

A transreflective liquid crystal display device is known, which has both a part performing transmissive display by using backlight as a light source and, a part performing reflective display by using external light as a light source. Because the liquid crystal display device is capable of using both the backlight and the external light at the same time, it can always provide a good display characteristic, regardless of being used in the indoors or the outdoors. For the transreflective liquid crystal display device, a discussion has been made from various perspectives, as to how a display characteristic of the transmissive display and that of the reflective display should be set.

As shown in FIG. 12, in a case where the transreflective liquid crystal display device has a transmissive display region whose liquid crystal layer has a layer thickness being set thinner than in a reflective display region, an optical path in the liquid crystal layer in the reflective display region has a length which is two times larger than that in the transmissive display region. This results in that the display characteristic of the transmissive display and that of the reflective display do not match each other as shown in FIG. 13.

As shown in FIG. 14, on the other hand, in a case where the transreflective liquid crystal display device has a reflective display region whose liquid layer has a layer thickness being set, by using members such as a layer thickness adjustment layer, to one half of that in the transmissive display region, an optical path in the liquid crystal layer in the reflective display region has a length which is the same as that in the transmissive display region. This results in that the display characteristic of the transmissive display and that of the reflective display match each other as shown in FIG. 15.

Accordingly, in designing of the transreflective liquid crystal display device, it is often configured so that the reflective display region has the liquid crystal layer whose layer thickness is set to be approximately one half of that in the transmissive display region.

In a liquid crystal display panel which drives a liquid crystal in a vertical alignment mode, an alignment regulator whereby alignment of the liquid crystal is regulated at time of voltage application is formed. A concrete example of the alignment regulator encompasses: a protrusion (alignment regulating protrusion) protruding from an electrode in a substrate into the liquid crystal layer; and a slit formed in the electrode in the substrate. The protrusion, in particular, effectively works as a base point whereby a liquid crystal molecule recovers alignment even when being disturbed by an external pressure. This allows the liquid crystal to have higher resistance to the external pressure, thereby making the protrusion indispensable in, for example, an ASV (Advanced Super View) liquid crystal. The ASV liquid crystal is directed to a technique of maintaining a wide viewing angle while the liquid crystal is driven in the vertical alignment mode. Examples of the ASV liquid crystal encompass: an MVA (Multi-domain Vertical Alignment) mode drive for dividing an alignment direction of liquid crystal molecules into 4 directions by using a lib and an electrode slit; a CPA (Continuous Pinwheel Alignment) mode drive for radially aligning liquid crystal molecules by using a rivet; and, the like drive.

FIG. 16 is a plane view of a pixel in a transreflective liquid crystal display device which is designed on the basis of above-described ideas and which drives the liquid crystal in a VA (vertical Alignment) mode. The reflective display region has the liquid crystal layer whose layer thickness is approximately one half of that in the transmissive display region. In the transmissive display region, a rivet 111 is formed, whereas in the reflective display region, a rivet 112 is formed. Each of the rivets 111 and 112 is a protrusion having a projecting-dot shape, and is formed as an alignment regulating protrusion for driving the liquid crystal in the vertical alignment mode. That is, the display in both the reflective display region and the transmissive display region is performed by driving the liquid crystal in the CPA mode. Documents such as patent literatures 1 and 2 disclose a configuration similar to the above.

A pixel PIXji in a row j, a column i is formed in a region surrounded by two adjacent scanning signal lines GLj−1 and GLj and two adjacent data signal lines SL and SL+1. Between the scanning signal lines GLj−1 and GL, a storage capacitance line CSL is formed in parallel with them. The pixel PIXji has (i) a reflective display region 201 which is formed approximately between the scanning signal line GLj and the storage capacitance line CSL and (ii) a transmissive display region 202 which is formed approximately between the storage capacitance line CSL and the scanning signal line GLj−1. The reflective display region 201 is larger in area than the transmissive display region 202.

For an intersection of the scanning signal line GLj and the data signal line SLi, a TFT 101 is provided. The TFT 101 has a gate electrode 101g connected with the scanning signal line GLj, and a source electrode 101s connected with the data signal line SLi. The TFT 101 has a drain electrode 101d routed to near a central part of the pixel PIXji and connected with a drain electrode pad 101dp. The drain electrode pad 101dp opposes to, via a gate insulating layer below, a storage capacitance line pad CSLp which is routed from the storage capacitance line CSL to near the central part of the pixel PIXji. This forms storage capacitance. A substantially entire part of the drain electrode pad 101dp and that of the storage capacitance line pad CSLp are formed within the reflective display region 201.

In a substantially entire part of the reflective display region 201, a reflective layer 102 is formed on an interlayer insulating layer formed above the drain electrode pad 101dp. On the reflective layer 102, a pixel electrode 103 is formed. The pixel electrode 103 is connected with the drain electrode pad 101dp via a contact hole 104 formed in the interlayer insulating layer. The pixel electrode 103 is formed across a region above the storage capacitance line CSL to reach the transmissive display region 202, and thereby constitutes a pixel electrode in the transmissive display region 202.

The descriptions above explain a configuration of the TFT substrate. The following describes, on the other hand, a configuration of a counter substrate. In the counter substrate, a rivet 111 is formed in a central part of the reflective display region 201, and a rivet 112 is formed in a central part of the transmissive display region 202. Each of the rivets 111 and 112 protrudes from a common electrode into a liquid crystal layer.

### Citation List

Patent Literature 1

Japanese Patent Application Publication, Tokukai, No. 2006-91229 A (Publication Date: Apr. 6, 2006)

Patent Literature 2

Japanese Patent Application Publication, Tokukai, No. 2005-258183 A (Publication Date: Sep. 22, 2005)

Patent Literature 3

Japanese Patent Application Publication, Tokukai, No. 2006-243185 A (Publication Date: Sep. 14, 2006)

### SUMMARY OF INVENTION

In a transreflective liquid crystal display device as shown in FIG. 16 which drives a liquid crystal in the vertical alignment mode, a transmissive display region and a reflective display region are designed in a substantially same way except that the transmissive display region has a liquid crystal layer whose layer thickness is thinner than in the reflective display region. However, because a liquid crystal in the thinner liquid crystal layer more quickly responds to a voltage, the liquid crystal in the reflective display region responds quicker than does a liquid crystal in the transmissive display region. This results in a problem in that a response speed of the transmissive display and that of the reflective display differ from each other.

Such a difference in the response speeds results in absence of an adequate condition for carrying out useful overdrive in improving the response speeds. As described in the patent literature 3, the overdrive is directed to an art of increasing a rise response speed of the liquid crystal. By the overdrive, (i) when positive data is supplied, a voltage is written down, starting from a voltage higher than a data signal that is supposed to be written down, whereas (ii) when negative data is supplied, a voltage is written down, starting from a voltage lower than a data signal that is supposed to be written down.

Accordingly, if the transreflective liquid crystal display device sets an overdriving condition in accordance with the transmissive display having a lower response speed, the reflective display will have a response in which luminance exceeds a desired value, because the reflective display has a higher response speed. This results in a deterioration of a display quality, such as trailing, in a reflective display screen. On the other hand, if the transreflective liquid crystal display device sets the overdriving condition in accordance with the reflective display having a higher response speed, the transmissive display will be overshot by a lesser degree, thereby resulting in that the luminance fails the desired value.

In view of the above, there is demand for the transreflective liquid crystal display device driving the liquid crystal in the vertical alignment mode, in which transreflective liquid crystal display device the response characteristic of the transmissive display and that of the reflective display can be made closer to each other without losing the indispensable alignment regulating protrusion.

The present invention is made in view of the conventional problem, and an object of the present invention is to realize a transreflective liquid crystal display panel and a transreflective liquid crystal display device each including an alignment regulating protrusion for driving a liquid crystal in a vertical alignment mode, in each of which transreflective liquid crystal display panel and transreflective liquid crystal display device a response characteristic of reflective display can be made closer to a response characteristic of transmissive display.

In order to attain the object, a liquid crystal display panel of the present invention is a liquid crystal display panel having pixel regions each having a transmissive display region and a reflective display region, wherein: the reflective display region has a substantially rectangular shape when viewed in a direction orthogonal to a panel plane; and the liquid crystal display panel includes a protrusion formed at and entirely along at least one edge of the reflective display region, the protrusion having a projecting-line shape whose width is in a direction orthogonal to that edge of the reflective display region in the panel plane at and along which the protrusion is provided, and the protrusion protruding into a liquid crystal layer in a layer thickness direction of the liquid crystal layer.

In the above invention, the protrusion having the projecting-line shape which works as an alignment regulator for driving the liquid crystal in a vertical alignment mode is formed at and entirely along at least one edge of the reflective display region. Therefore, unlike in a conventional case where the alignment regulator is a rivet, the reflective display region has a smaller area in which a distance between the alignment regulating protrusion and that edge of the reflective display region which is away from the alignment regulating protrusion is small. As a result, it takes a longer time to complete propagation of tilting liquid crystals in the reflective display region. Thus, the liquid crystal layer in the reflective display region has a lower response speed as compared with the conventional case. Accordingly, the response speed in the reflective display region and that in the transmissive display region can be made closer to each other, as compared with the conventional case. As a result, a proper condition for the overdrive can be set for both the reflective display and the transmissive display.

Therefore, it is possible to realize the transreflective liquid crystal display panel including the alignment regulating protrusion for driving the liquid crystal in the vertical alignment mode, in which transreflective liquid crystal display panel the response characteristic of the reflective display can be made closer to that of the transmissive display.

In order to attain the object, the liquid crystal display panel of the present invention is configured so that the reflective display region has a substantially oblong shape; and the protrusion is formed at and entirely along only one short edge or one long edge of the reflective display region.

In the above invention, the protrusion having the projecting-line shape is formed at and entirely along only one short edge or one long edge of the reflective display region, thereby resulting in a profounder effect that removes the area being present in the case where the alignment regulator is the rivet, in which area the distance between the alignment regulating protrusion and an edge of the reflective display region is small. This can notably lower the response speed in the reflective display region, thereby bringing about an affect that makes the response characteristic of the reflective display closer to that of the transmissive display.

In order to attain the object, the liquid crystal display panel of the present invention is configured so that: the reflective display region has a substantially oblong shape; and the protrusion is formed at and entirely along one short edge and one long edge of the reflective display region.

In the above invention, the protrusion having the projecting-line shape is formed at and entirely along only one short edge and one long edge of the reflective display region, thereby resulting in a profounder effect that removes the area being present in the case where the alignment regulator is the rivet, in which area the distance between the alignment regulating protrusion and an edge of the reflective display region is small. This can notably lowers the response speed in the reflective display region, thereby bringing about an effect that makes the response characteristic of the reflective display closer to that of the transmissive display.

In order to attain the object, a liquid crystal display panel of the present invention is configured to be a liquid crystal display panel having pixel regions each having a transmissive display region and a reflective display region, wherein: the reflective display region has a substantially rectangular shape when viewed in a direction orthogonal to a panel plane; and the liquid crystal display panel includes a protrusion being extended orthogonally to and connecting, with each other, a pair of opposite two edges of the reflective display region in a panel plane, the protrusion having a projecting-line shape whose width is in a direction parallel with the pair of opposite two edges in the panel plane, and the protrusion protruding into a liquid crystal layer in a layer thickness direction of the liquid crystal layer.

In the above invention, the protrusion having the projecting-line shape which works as the alignment regulator for driving the liquid crystal in the vertical alignment mode is extended orthogonally to and connects, with each other, the pair of opposite two edges of the reflective display region in the panel plane. As such, unlike in the conventional case where the alignment regulator is the rivet, the reflective display region has a smaller area in which a distance between the alignment regulating protrusion and that end of the reflective display region which is away from the alignment regulating protrusion is small. As a result, it takes a longer time to complete propagation of tilting liquid crystal molecules in the reflective display region. This lowers the response speed of the liquid crystal layer in the reflective display region, as compared with the conventional case. Accordingly, the response speed in the reflective display region and that in the transmissive display region can be made closer to each other as compared with the conventional case. As a result, a proper condition for the overdrive can be set for both the reflective display and the transmissive display.

Therefore, it is possible to realize the transreflective liquid crystal display panel including the alignment regulating protrusion for driving the liquid crystal in the vertical alignment mode, in which transreflective liquid crystal display panel the response characteristic of the reflective display can be made closer to that of the transmissive display.

In order to attain the object, the liquid crystal display panel of the present invention is configured so that: the reflective display region has the substantially oblong shape; and the pair of opposite two edges are long edges.

In the above invention, the protrusion having the projecting-line shape connects the pair of opposite two edges, thereby resulting in a profounder effect that removes the area being present in the case where the alignment regulator is the rivet, in which area the distance between the alignment regulating protrusion and an edge of the reflective display region is small. This can notably lower the response speed in the reflective display region, thereby making the response characteristic of the reflective display closer to that of the transmissive display.

In order to attain the object, the liquid crystal display panel of the present invention is configured so that the protrusion bisects the region having the substantially rectangular shape when viewed in the direction orthogonal to the panel plane.

In the above invention, the protrusion having the projecting-line shape bisects the region having the substantially rectangular shape, thereby bringing about an effect that allows regions on both sides of the protrusion to have minimum response speeds, respectively, which are same with each other.

In order to attain the object, a liquid crystal display panel of the present invention is configured so as to be a liquid crystal display panel having pixel regions each having a transmissive display region and a reflective display region, wherein: the reflective display region has a substantially rectangular shape when viewed in a direction orthogonal to a panel plane; and the liquid crystal display panel includes one protrusion formed at and entirely along one diagonal line of the reflective display region, the protrusion having a projecting-line shape whose width is in a direction orthogonal to the one diagonal line in the panel plane, and the protrusion protruding into a liquid crystal layer in a layer thickness direction of the liquid crystal layer.

In the above invention, the protrusion having the projecting-line shape which works as the alignment regulator for driving the liquid crystal in the vertical alignment mode is formed at and entirely along one diagonal line of the reflective display region. As such, unlike in the conventional case where the alignment regulator is the rivet, the reflective display region has a smaller area in which a distance between the alignment regulating protrusion and that end of the reflective display region which is away from the alignment regulating protrusion is small. As a result, it takes a longer time to complete propagation of tilting liquid crystal molecules in the reflective display region. This lowers the response speed of the liquid crystal layer in the reflective display region, as compared with the conventional case. Accordingly, the response speed in the reflective display region and that in the transmissive display region can be made closer to each other as compared with the conventional case. As a result, a proper condition for the overdrive can be set for both the reflective display and the transmissive display.

Therefore, it is possible to realize the transreflective liquid crystal display panel including the alignment regulating protrusion for driving the liquid crystal in the vertical alignment mode, in which transreflective liquid crystal display panel the response characteristic of the reflective display can be made closer to that of the transmissive display.

In order to attain the object, the liquid crystal display panel of the present invention is configured so that the reflective display region has a substantially oblong shape.

In the above invention, the protrusion having the projecting-line shape is formed at and entirely along one diagonal line of the reflective display region, thereby resulting in a profounder effect that removes the area being present in the case where the alignment regulator is the rivet, in which area a distance between the alignment regulating protrusion and an edge of the reflective display region is small. This can notably lowers the response speed in the reflective display region, thereby bringing about an effect that makes the response characteristic of the reflective display closer to that of the transmissive display.

In order to attain the object, a liquid crystal display panel of the present invention is configured so as to be a liquid crystal display panel having pixel regions each having a transmissive display region and a reflective display region, wherein: the reflective display region consists of a plurality of regions connected with one another, each of which regions has a substantially rectangular shape; and the liquid crystal display panel includes one protrusion formed at and entirely along one diagonal line of the each of the plurality of the regions, the protrusion having a projecting-line shape whose width is in a direction orthogonal to the one diagonal line in the panel plane, and the protrusion protruding into a liquid crystal layer in a layer thickness direction of the liquid crystal layer.

In the above invention, the protrusion having the projecting-line shape which works as the alignment regulator for driving the liquid crystals in the vertical alignment mode is formed at and entirely along one diagonal line of the each of the plurality of the regions. As such, unlike in the conventional case where the alignment regulator is the rivet, the reflective display region has a smaller area in which distances between the alignment regulating protrusion and those ends of the reflective display region which are away from the alignment regulating protrusion are small. As a result, it takes a longer time to complete propagation of tilting liquid crystal molecules in the reflective display region. This lowers the response speed of the liquid crystal layer in the reflective display region, as compared with the conventional case. Accordingly, the response speed in the reflective display region and that in the transmissive display region can be made closer to each other as compared with the conventional case. As a result, a proper condition for the overdrive can be set for both the reflective display region and the transmissive display region.

Therefore, it is possible to realize the transreflective liquid crystal display panel including the alignment regulating protrusion for driving the liquid crystal in the vertical alignment mode, in which transreflective liquid crystal display panel the response characteristic of the reflective display can be made closer to that of the transmissive display.

In order to attain the object, the liquid crystal display panel of the present invention is configured so that: the plurality of the regions each having the substantially rectangular shape are two regions wherein the one diagonal line of one of the two region is extended in a different direction from that of the other of the two regions.

In the above invention, one of the two regions has one diagonal line being extended in the different direction from that of the other of the two regions. As such, it is possible to easily divide a domain into multiple domains by using the protrusion, thereby allowing MVA mode driving of the liquid crystal. This brings about an effect that lowers the response speed of the reflective display while maintaining a wide viewing angle property of the liquid crystal display panel.

In order to attain the object of the present invention, the liquid crystal display panel of the present invention is configured so that each of the two regions has the one diagonal line, which forms an angle of 45° with both of a scanning signal line and a data signal line orthogonal to each other.

In the above invention, each of the two regions has one diagonal line forming the angle of 45° with both the scanning signal line and the data signal line orthogonal to each other, thereby bringing about an effect that easily provides an uniform viewing angle property of the liquid crystal display panel.

In order to attain the object of the present invention, the liquid crystal display panel of the present invention is configured so that, in the transmissive display region of each pixel region, a protrusion having a projecting-dot shape when viewed in a direction orthogonal to the panel plane is formed, the protrusion protruding into the liquid crystal layer in the layer thickness direction of the liquid crystal layer.

In the above invention, the protrusion having the projecting-dot shape works as the alignment regulator. In the transreflective liquid crystal display device, this brings about an effect that increases the response speed in the transmissive display region so as to maintain a good response characteristic, and so as to makes it easier that the response speed of the reflective display is made closer to that in the transmissive display region.

In order to attain the object, the liquid crystal display panel of the present invention is configured so that in each pixel region, (i) the reflective display region has a pixel electrode which is connected to a pixel electrode in the transmissive display region, and (ii) when viewed in a direction orthogonal to the panel plane, the protrusion having the projecting-line shape is formed in such a manner that the protrusion avoids a connection part via which the pixel electrode in the reflective display region is connected to the pixel electrode in the transmissive display region.

The above invention brings about an effect that makes it less likely that the protrusion having the projecting-line shape affects the response by the liquid crystal molecule in the transmissive display region.

In order to attain the object, the liquid crystal display panel of the present invention is configured so that in each pixel region, the reflective display region is larger in area than the transmissive display region when viewed in a direction orthogonal to the panel plane.

In the above invention, the reflective display region is larger in area than the transmissive display region, thereby resulting in a greater delay in propagation of tilting liquid crystal molecules. This brings about an effect that makes the response speed in the reflective display region closer to that in the transmissive display region in proportion to the delay.

In order to attain the object of the present invention, the liquid crystal display device of the present invention is configured so that the liquid crystal layer is thicker in the reflective display region than in the transmissive display region.

In a configuration which is generally used in making the response characteristic of the reflective display closer to that in the transmissive display region, the reflective display region has a thinner liquid crystal layer, thereby resulting in a high response speed of reflective display. However, the above invention brings about an effect that particularly effectively lowers the high response speed of the reflective display by using the protrusion having the projecting-line shape.

In order to attain the object, a liquid crystal display device of the present invention includes the liquid crystal display panel described hereinabove.

The above invention brings about an effect that realizes the transreflective liquid crystal display device including the alignment regulating protrusion for driving the liquid crystal in the vertical alignment mode, in which transreflective liquid crystal display device the response characteristic of the reflective display can be made closer to that of the transmissive display.

For a fuller understanding of the nature and advantages of the invention, reference should be made to the ensuing detailed description taken in conjunction with the accompanying drawings.

### BRIEF DESCRIPTION OF DRAWINGS

FIG. 1 is a plane view of the present embodiment, showing a first configuration of a pixel in a liquid crystal display panel including a transmissive display region and a reflective display region.

FIG. 2 is a cross sectional view of the pixel in FIG. 1, taken on a line A-B.

FIG. 3 is a cross section view of the pixel in FIG. 1, taken on a line C-D.

FIG. 4 is a cross sectional view of the pixel in FIG. 1, taken on a line E-F.

FIG. 5 is a plane view of the present embodiment, showing a second configuration of the pixel in the liquid crystal display panel including the transmissive display region and the reflective display region.

FIG. 6 is a plane view of the present embodiment, showing a third configuration of the pixel in the liquid crystal display panel including the transmissive display region and the reflective display region.

FIG. 7 is a plane view of the present embodiment, showing a fourth configuration of the pixel in the liquid crystal display panel including the transmissive display region and the reflective display region.

FIG. 8 is a plane view of the present embodiment, showing a fifth configuration of the pixel in the liquid crystal display panel including the transmissive display region and the reflective display region.

FIG. 9 is a plane view of the present embodiment, showing a sixth configuration of the pixel in the liquid crystal display panel including the transmissive display region and the reflective display region.

FIG. 10 shows a graph showing response characteristics of the reflective display and the transmissive display in the liquid crystal display panel.

FIG. 11 is a block diagram of the present embodiment, showing a configuration of the liquid crystal display panel including the transmissive display region and the reflective display region.

FIG. 12 is a cross sectional view of a conventional technique, showing a first example of a layer thickness of a liquid crystal layer in a liquid crystal display device having a transmissive display region and a reflective display region.

FIG. 13 is a graph showing response characteristic in the liquid crystal display device shown in FIG. 12.

FIG. 14 is a cross sectional view of a conventional technique, showing a second example of a layer thickness of a liquid crystal layer in a liquid crystal display device having a transmissive display region and a reflective display region.

FIG. 15 is a graph showing response characteristics in the liquid crystal display device shown in FIG. 14.

FIG. 16 is a plane view of the conventional technique, showing a configuration of a pixel in the liquid crystal display device having the transmissive display region and the reflective display region.

FIG. 17 is a plane view of the present embodiment, showing a seventh configuration of the pixel in the liquid crystal display panel having the transmissive display region and the reflective display region.

FIG. 18 is a plane view of the present embodiment, showing an eighth configuration of the pixel in the liquid crystal display panel having the transmissive display region and the reflective display region.

FIG. 19 is a plane view of the present embodiment, showing a ninth configuration of the pixel in the liquid crystal display panel having the transmissive display region and the reflective display region.

### BRIEF DESCRIPTION OF REFERENCE NUMERALS

1. Display panel (Liquid crystal display panel)
21, 21′. Reflective display region
22. Transmissive display region
51, 53, 54, 55, 56, 61a, 61b, 72. Lib (Protrusion having a projecting-line shape)
52. Rivet (Protrusion having a projecting-dot shape)
GLj. Scanning signal line
SLj. Data signal line
PIXji. Pixel

### Description of Embodiments

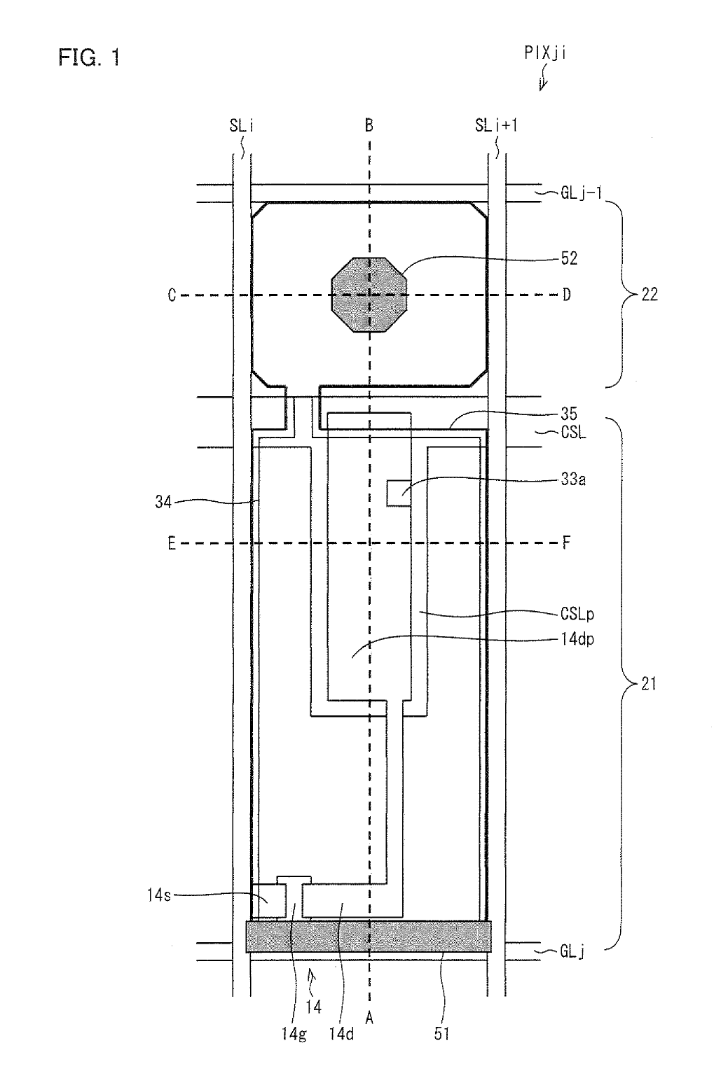

One embodiment of the present invention is explained below with reference to FIGS. 1 through 11 and 17 through 19.

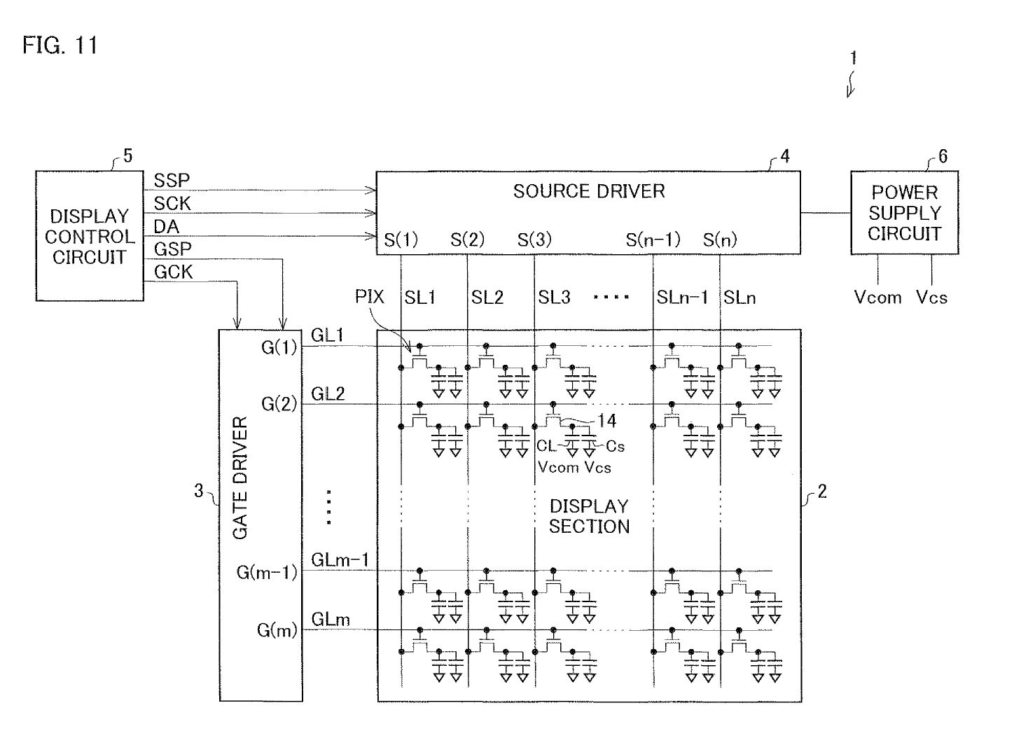

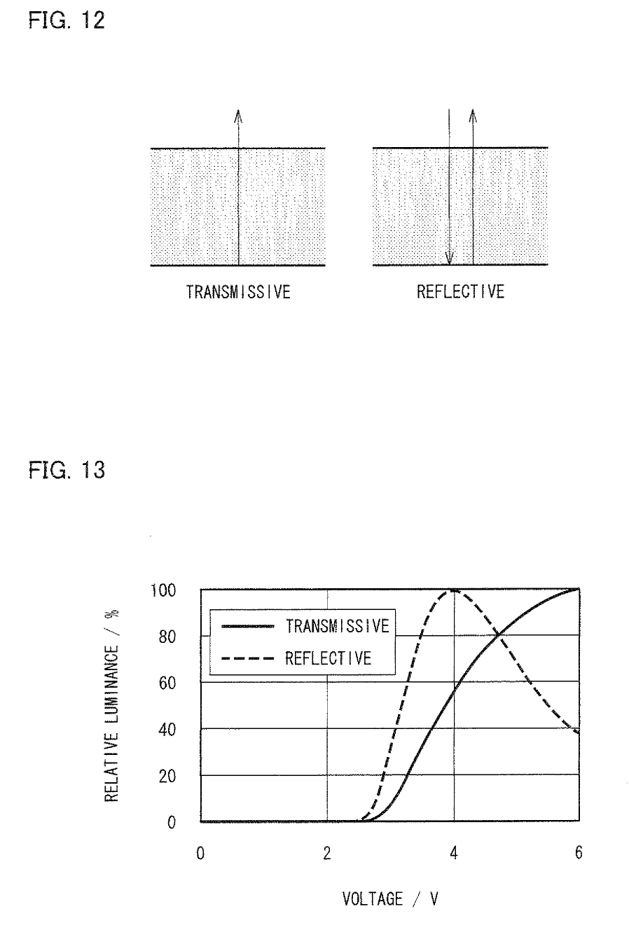

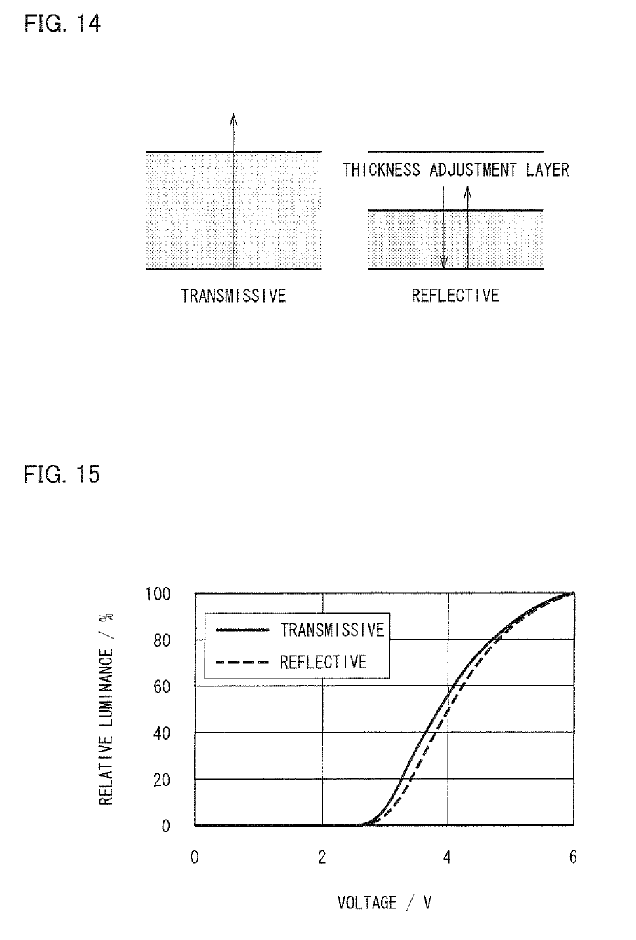

FIG. 11 shows a configuration of a display panel (liquid crystal display panel) 1 in a transreflective liquid crystal display device in accordance with a present embodiment.

The display panel 1 is of an active matrix display device, which includes a gate driver 3 as a scanning signal line driving circuit, a source driver 4 as a data signal line driving circuit, a display section 2, a display control circuit 5 for controlling the gate driver 3 and the source driver 4, and a power supply circuit 6.

The display section 2 includes: a plurality of (m number of) gate lines GL1 through GLm as the scanning signal lines; a plurality of (n number of) source lines SL1 through SLn as the data signal lines; and a plurality of (m×n number of) pixels PIX. The gate lines GL1 through GLm and the source lines SL1 through SLn intersect each other, and for each intersection, a pixel PIX is provided. Further, though it is not illustrated in the drawing, the display section 2 includes storage capacitance lines CSL in parallel with the gate lines GL1 through GLm (see FIG. 1 which is described later), each of which storage capacitance lines CSL is provided for a pixel column constituted by the n number of the pixels lining up in parallel with corresponding one of the gate signal lines GL1 through GLm.

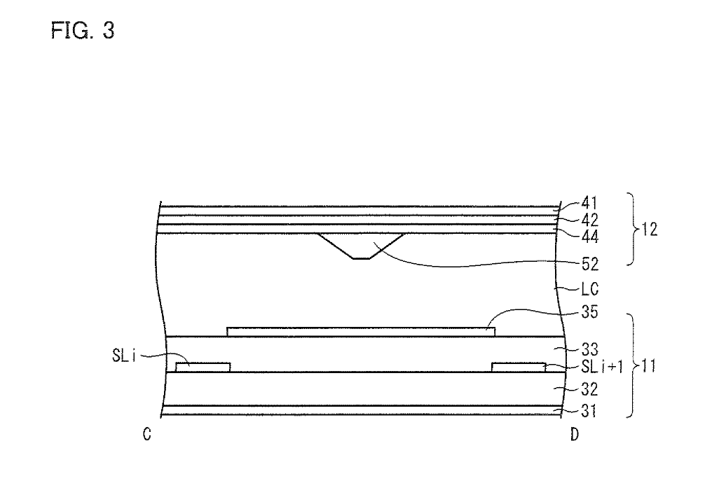

A plurality of the pixels PIX is provided in a matrix manner, thereby constituting pixel array. Each of the pixels PIX includes a TFT 14. For each of the pixels PIX, liquid crystal capacitance CL and storage capacitance Cs are provided. The TFT 14 has a gate electrode 14g connected with a gate line GLj (1≦j≦m), a source electrode 14s connected with a source line SLi (1≦i≦m), and a drain electrode 14d connected with a pixel electrode 35 (see FIG. 1 which is described later). The liquid crystal capacitance CL is formed by (i) a pixel electrode 35, (ii) a common electrode 44 (see FIG. 3) opposing to the pixel electrode 35, and (iii) a liquid crystal layer sandwiched by the pixel electrode 35 and the common electrode 44. The common electrode 44 is applied with a voltage Vcom from the power supply circuit 6. The liquid crystal capacitance CL and the storage capacitance Cs form pixel capacitance, but capacitance forming the pixel capacitance is not limited to them. Parasitic capacitance formed between the pixel electrode 35 and a surrounding wiring line also forms the pixel capacitance.

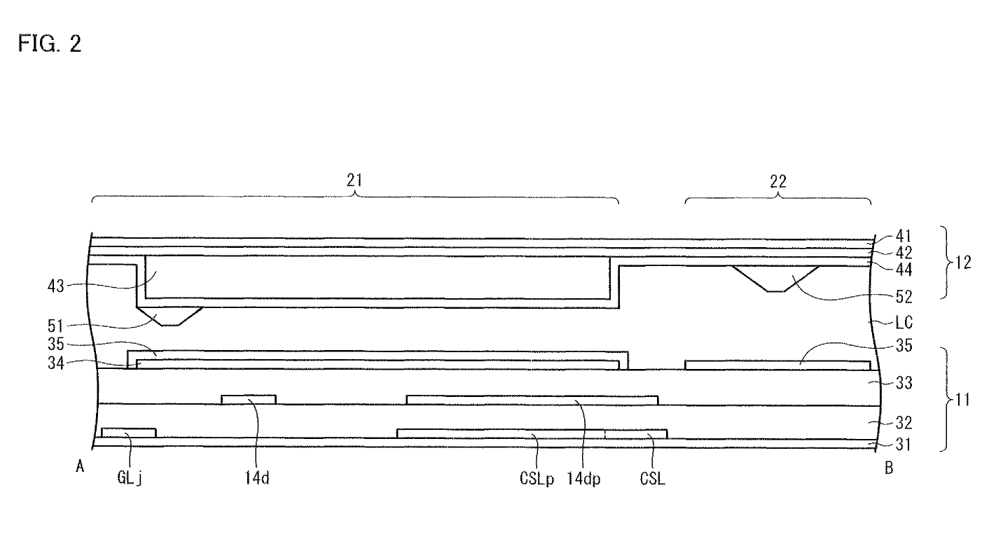

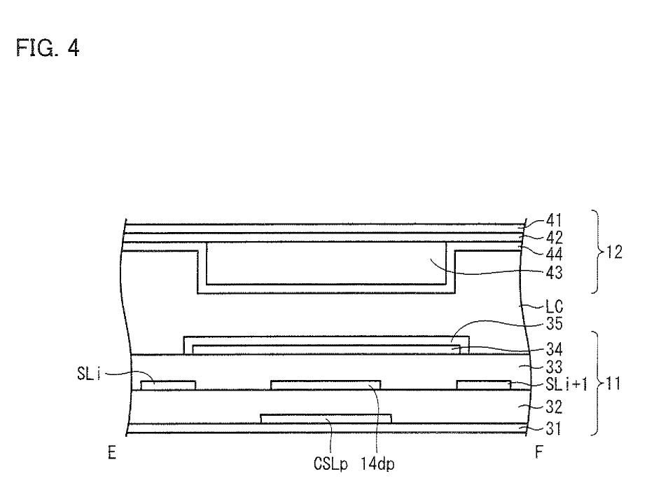

FIG. 1 shows a plane view of a pixel PIX. FIG. 2 shows a cross sectional view of the pixel PIX in FIG. 1, taken on a line A-B. FIG. 3 shows a cross sectional view of the pixel PIX in FIG. 1, taken on a line C-D. FIG. 4 shows a cross sectional view of the pixel PIX in FIG. 1, taken on a line E-F.

As shown in FIG. 1, a pixel PIXji in a row j, a column i is a region surrounded by two adjacent scanning signal lines GLj−1 and GLj and two adjacent data signal lines SLi and SLi+1. Between the scanning signal lines GLj−1 and GLj, a storage capacitance line CSL is provided in parallel with them. The pixel PIXji includes (i) a reflective display region 21 which is formed substantially between the scanning signal line GLj and the storage capacitance line CSL, and (ii) a transmissive display region 22 which is formed substantially between the storage capacitance line CSL and the scanning signal line GLj−1. The reflective display region 21 is formed above a reflective layer 34 (which is described later). The reflective display region 21 may include a storage capacitance formation region in a case where the storage capacitance formation region is formed around the reflective display region 21. The reflective display region 21 has a substantially rectangular shape when viewed in a direction orthogonal to a panel plane. In particular, the reflective display region 21 has a substantially oblong shape whose short sides are in parallel with the scanning signal line GLj and the storage capacitance line CSL, and whose long sides are in parallel with the data signal line SLi. The transmissive display region 22 is formed above a region which does not have any light non-transmissive layer such as a reflection layer 52, a gate metal, or a source metal. The transmissive display region 22 may include a storage capacitance formation region in a case where the storage capacitance formation region is formed around the transmissive display region 22. The reflective display region 21 is larger in area than the transmissive display region 22.

For an intersection of the scanning signal line GLj and the data signal line SLi, the TFT 14 is provided. The TFT 14 has the gate electrode 14g connected with the scanning signal line GLj, and the source electrode 14s connected with the data signal line SLi. The TFT 14 has the drain electrode 14d, which is routed to near a central part of the pixel PIXji so as to be connected with a drain electrode pad 14dp. The drain electrode pad 14dp opposes to, via a gate insulating layer 32 provided below (see FIG. 2 which is described later), a storage capacitance line pad CSLp routed from the storage capacitance line CSL to near the central part of the pixel PIXji. This forms the storage capacitance Cs. A substantially entire part of the drain electrode pad 14dp and that of the storage capacitance line pad CSLp are formed within the reflective display region 21.

In the reflective display region 21, furthermore, the reflection layer 34 is formed on an interlayer insulating layer 33 which is formed above the drain electrode pad 14dp. On the reflection layer 34, the pixel electrode 35 constituted by a transparent electrode is provided. The pixel electrode 35 is connected with the drain electrode pad 14dp via a contact hole 33a formed in the interlayer insulating layer 33. Further, the transparent electrode 35 is extended to the transmissive display region 22 across a region above the storage capacitance lines CSL, and thereby constitutes a transparent electrode in the transmissive display region 22.

The above descriptions explain a configuration of the TFT substrate 11 (see FIG. 2). In a counter substrate 12 (see FIG. 2), a lib (protrusion having a projecting-line shape) 51 is formed at and entirely along that edge of the reflective display region 21 which is close to the scanning signal line GLj, i.e., the lib 51 is formed entirely in a region above the edge. The lib 51 protrudes from the common electrode 44 into a liquid crystal layer LC. That edge of the reflective display region 21 which is close to the scanning signal line GLj is a short edge of the reflective display region 21 having the substantially oblong shape. The lib 51 has a width in a direction orthogonal to the short edge of the reflective display region 21 in the panel plane. In this case, the lib 51 has the width in a direction which is orthogonal to that direction in the panel plane in which the scanning signal line GLj is extended. Furthermore, in a central part of the transmissive display region 22, a rivet (protrusion having a projecting-dot shape) 52 is formed, and protrudes from the common electrode 44 into the liquid crystal layer LC. Each of the lib 51 and the rivet 52 works as a liquid crystal alignment regulator.

Next, a cross sectional configuration of the pixel PIXji is explained below with reference to FIGS. 2 through 4.

As is clear in FIGS. 2 through 4, the pixel PIXji includes the TFT substrate (active matrix substrate) 11, a counter substrate 12, and the liquid crystal layer LC sandwiched by the TFT substrate 11 and the counter substrate 12.

The TFT substrate 11 is configured so that on the transparent insulating substrate 31, a gate metal constitutes (i) the scanning signal line GLj, the gate electrode 14g (which is not illustrated), (ii) the storage capacitance line CSL, and (iii) the storage capacitance line pad CSLp in a same layer. A gate insulating layer 23 is formed so as to cover the above members. On the gate insulating layer 32, a source metal constitutes (i) the data signal line SLi, (ii) the source electrode 14s (which is not illustrated), (iii) the drain electrode 14d, and (iv) the drain electrode pad 14dp (which is not illustrated) in a same layer. The interlayer insulating layer 33 is formed so as to cover the above members. On the interlayer insulating layer 33, the reflection layer 34 is formed in the reflective display region 21. On the interlayer insulating layer 33 on which the reflection layer 34 is formed, the pixel electrode 35 is formed. An alignment layer (which is not illustrated) is formed so as to cover the pixel electrode 35.

In the counter substrate 12, a color filter 42 is formed on a transparent insulating substrate 41. On the color filter 42, a layer thickness adjustment layer 43 for the liquid crystal layer is formed. The layer thickness adjustment layer 43 is formed so as to adjust a layer thickness of the liquid crystal layer in the reflective display region 21 to a fixed value, such as one half of the layer thickness of the liquid crystal layer in the transmissive display region 22. The common electrode 44 is formed so as to cover the color filter on which the layer thickness adjustment layer 43 is formed. On the common electrode 44 formed on the layer thickness adjustment layer 43, the lib 51 is formed above that end of the reflective display region 21 which is close to the scanning signal line GLj. The lib 51 is made from a material such as a dielectric material or the like, and has an arched shape tapered with a cross sectional area toward a tip into the liquid crystal layer LC. On the common electrode 44 in the transmissive display region 22, the rivet 52 is provided. The rivet 52 is made from a material such as a dielectric material or the like, and has a conical-trapezoidal shape tapered with a cross sectional area toward a tip into the liquid crystal layer LC. An alignment layer (which is not illustrate) is formed so as to cover the common electrode 44 on which the lib 51 and the rivet 52 are formed.

The liquid crystal layer LC in the reflective display region 21 is driven in the vertical alignment mode by using the lib 51, whereas the liquid crystal layer LC in the transmissive display region 22 is driven in the vertical alignment mode, in particular in the CPA mode, by using the rivet 52. The pixel PIXji, as a whole, functions as a pixel for an ASV liquid crystal.

In the present embodiment, as shown in each of FIGS. 1 through 4, the alignment regulating projection (lib 51) in the reflective display region 21 is formed along the edge of the reflective display region 21 instead of the central part of the reflective display region 21. In the vertical alignment mode drive, liquid crystal molecules tilt when the liquid crystal layer LC is applied with a voltage, in such a way that the liquid crystal molecules start tilting continuously from one of (i) the alignment regulating protrusion and (ii) an end of a pixel electrode region to the other. The alignment regulating projection works effectively even when no voltage is applied, and is indispensable, as described earlier, for the ASV liquid crystal to have higher resistance to an external pressure. The end of the pixel electrode region is, on the other hand, generally used as a pixel edge, and determines a direction of liquid crystal alignment only when a voltage is applied.

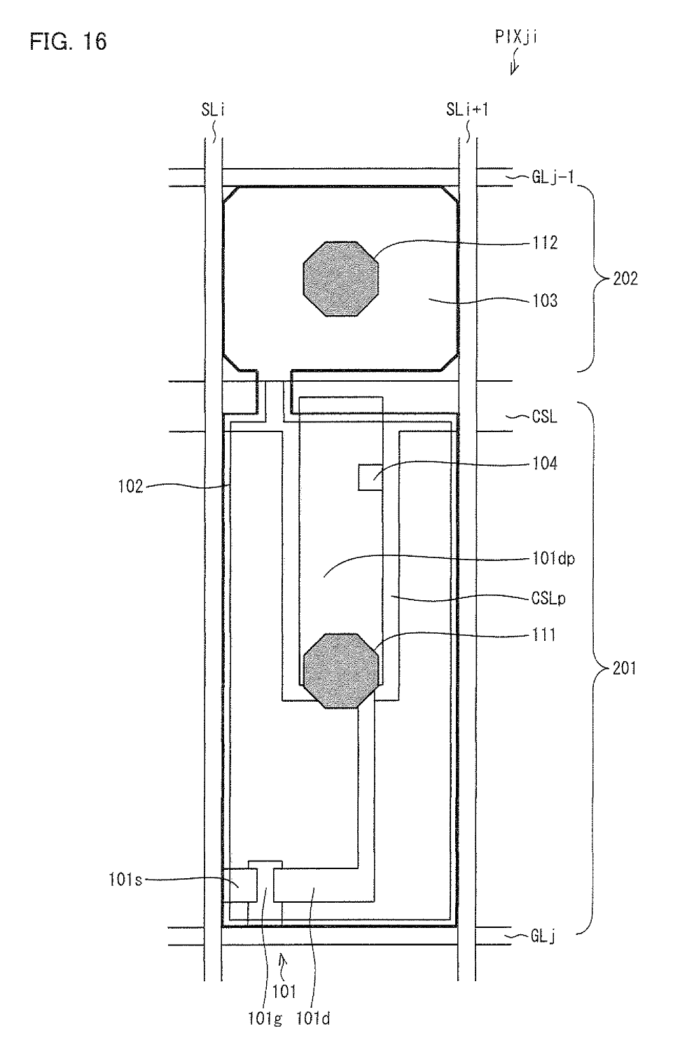

In a conventional transreflective liquid crystal display device as shown in FIG. 16, a rivet 111 is formed in a central part of the reflective display region 201, the rivet 111 being an alignment regulating protrusion in the reflective display region 201. As such, the reflective display region 201 has a large area in which a distance between the alignment regulating protrusion and an end of the reflective display region 201 (i.e., end of a reflective layer 102) is small. As a result, it takes a shorter time to complete propagation of tilting liquid crystal in the reflective display region 201. As such, the liquid crystal layer LC in the reflective display region 201 has a higher response speed. On the other hand, as in each of the configurations shown by FIGS. 1 through 4, the reflective display region 21 has a smaller area in which a distance between the lib 51 (the alignment regulating protrusion) and that end of the reflective display region 21 which is away from the lib 51 is small. As a result, it takes a longer time to complete propagation of tilting liquid crystal in the reflective display region 21. Accordingly, the liquid crystal layer LC in the reflective display region 21 has a lower response speed as compared with the conventional case. Meanwhile, an alignment regulating protrusion in the transmissive display region 22 is a rivet 52, which is formed in a central part of the transmissive display region 22 as in the conventional case. Thus, the response speed in the transmissive display region 22 is the same as in the conventional case. Accordingly, the response speed in the reflective display region 21 can be made closer to that in the transmissive display region 22 as compared with the conventional case. That is, the response speed of the reflective display can be made closer to that of the transmissive display as compared with the conventional case. As a result, a proper condition for the overdrive can be set for both the reflective display and the transmissive display.

Next, the following describes a type of the alignment regulating protrusion in accordance with the present embodiment.

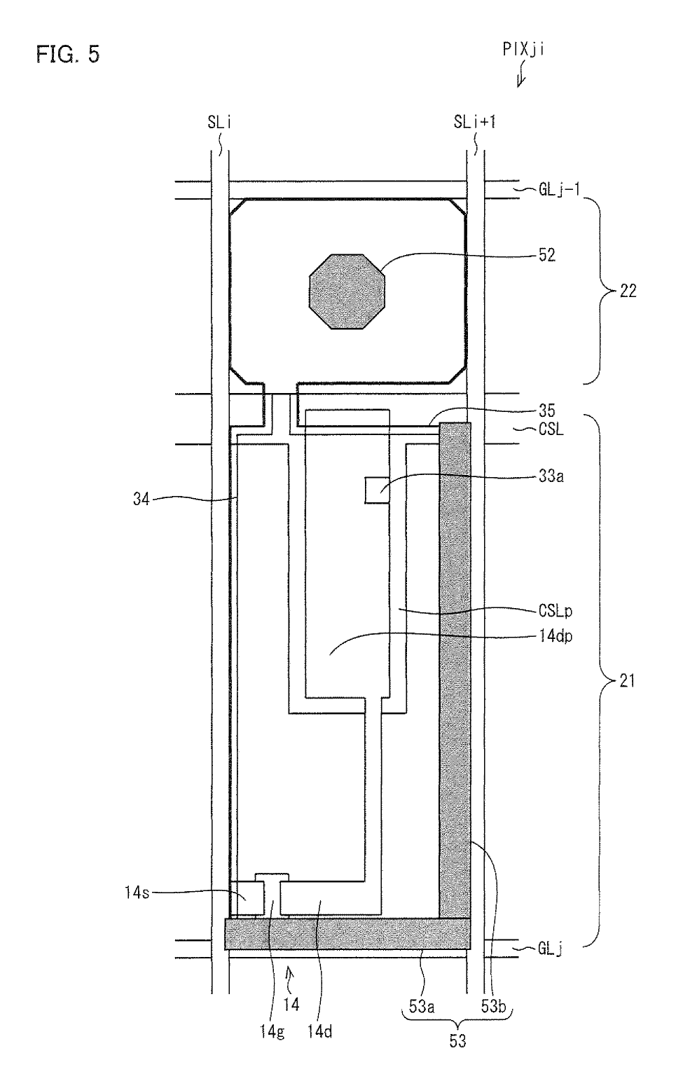

FIG. 5 is a plane view of a pixel PIXji which differs from the pixel PIXji in FIG. 1 in that a lib 53, instead of the lib 51, is included as an alignment regulating protrusion.

The lib 53 is constituted of a lib 53a and a lib 53b. The lib 53a is formed at and entirely along that edge of a reflective display region 21 which is above a scanning signal line SLi+1. On the other hand, the lib 53b is formed at and entirely along that edge of the reflective display region 21 which is above a data signal line SLi+1. The lib 53a is a protrusion having a projecting-line shape, whose width is in a direction orthogonal to that edge of the reflective display region 21 in a panel plane at and along which the lib 53a is provided. The lib 53b is a protrusion having a projecting-line shape, whose width is in a direction orthogonal to that edge of the reflective display region 21 in the panel plane at and along which the lib 53b is provided. Further, each of the lib 53a and the lib 53b has the same shape as the lib 51 and protrudes in the same direction as the lib 51. Therefore, a liquid crystal layer LC in the reflective display region 21 is driven in the vertical alignment mode.

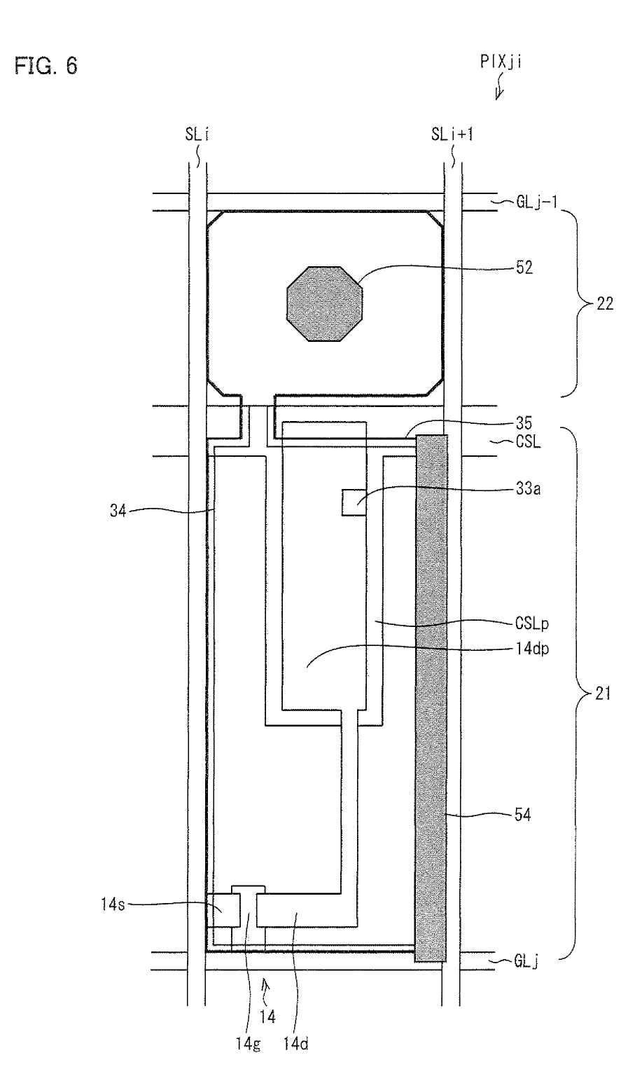

FIG. 6 is a plane view of a pixel PIXji which differs from the pixel PIX in FIG. 1 in that a lib 54, instead of the lib 51, is provided as an alignment regulating protrusion.

The lib 54 is formed at and entirely along that edge of a reflective display region 21 which is above a data, signal line SLi+1. The lib 54 is a protrusion having a projecting-line shape, whose width is in a direction orthogonal to that edge of the reflective display region 21 in a panel plane at and along which the lib 54 is provided. The lib 54 has the same shape as the lib 51 and protrudes in the same direction as the lib 51. Therefore, a liquid crystal layer LC in the reflective display region 21 is driven in the vertical alignment mode.

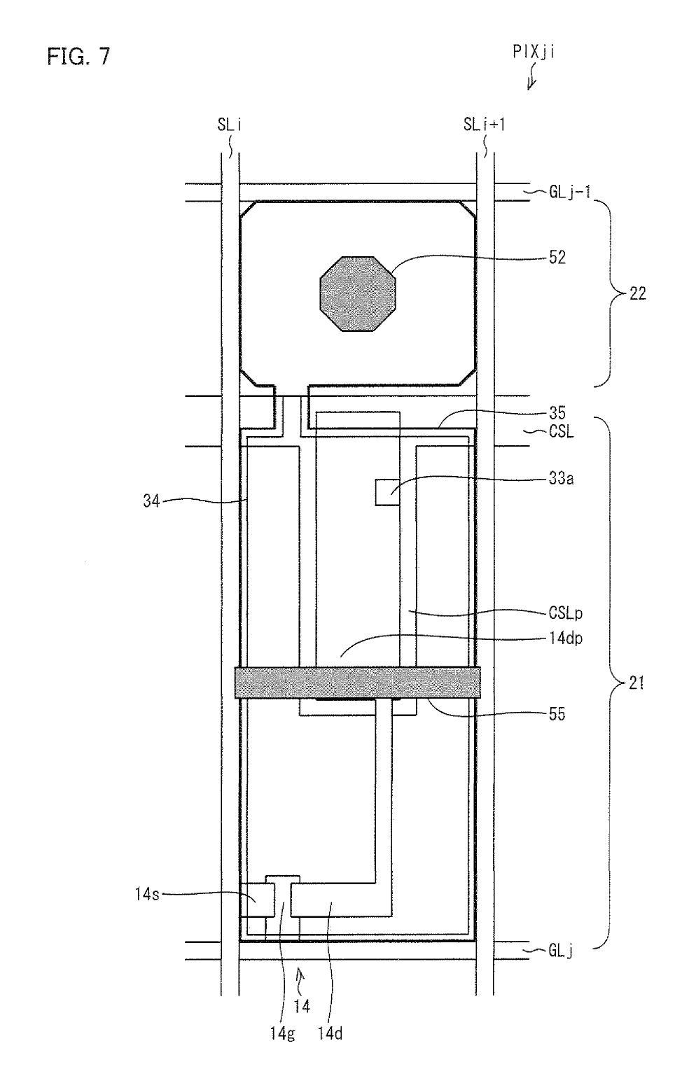

FIG. 7 is a plane view showing a pixel PIXji which differs from the pixel PIXji in FIG. 1 in that a lib 55, instead of the lib 51, is provided as an alignment regulating protrusion.

The lib 55 is provided across a pair of opposite two edges (in this case, a pair of long sides of the oblong shape) of the reflective display region 21, in a direction orthogonal to the pair of opposite two edges of the reflective display region 21 in a panel plane. The lib 55 is a protrusion having a projecting-line shape, whose width is in a direction parallel to the pair of the opposite two edges in the panel plane. The lib 55 has the same shape as the lib 51 and protrudes in the same direction as the lib 51. Further, the lib 55 bisects the reflective display region 21 when viewed in a direction orthogonal to the panel plane. As such, a liquid crystal layer LC in the reflective display region 21 is driven in the vertical alignment mode.

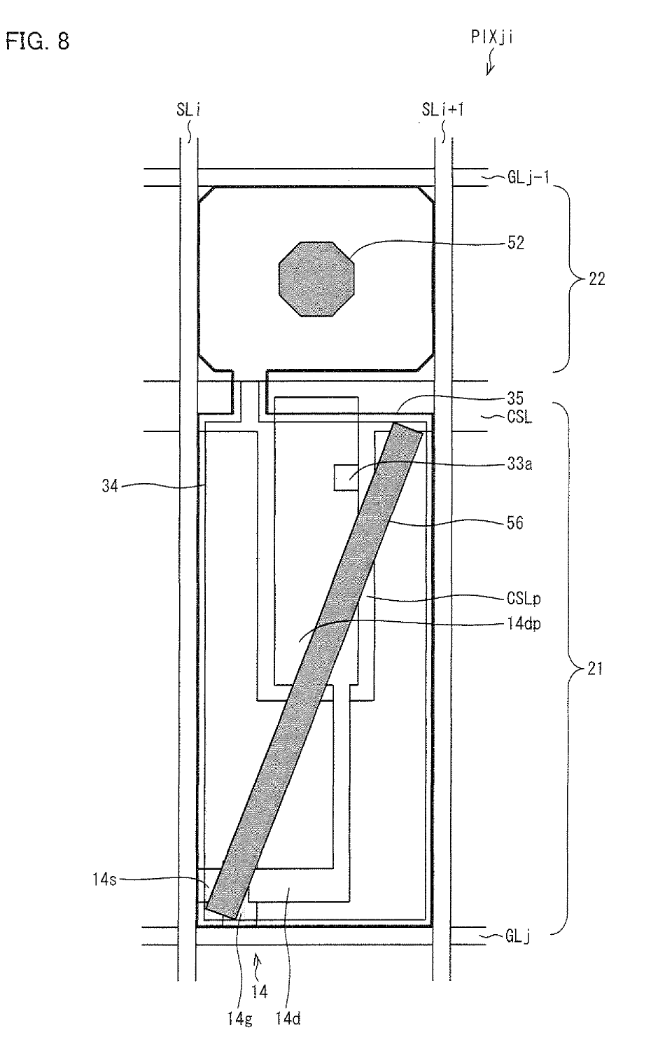

FIG. 8 is a plane view of a pixel PIXji which differs from the pixel PIXji in FIG. 1 in that a lib 56, instead of the lib 51, is included as an alignment regulating protrusion.

The lib 56 is formed at and entirely along one of diagonal line of a reflective display region 21. It is to be noted that the drawing is a simplified view of the pixel PIXji, and that the lib 56 is formed entirely in a region above the diagonal line. The lib 56 is a protrusion having a projecting-line shape, whose width is in a direction orthogonal to the diagonal line in a panel plane. The lib 56 has the same shape as the lib 51 and protrudes in the same direction as the lib 51. Therefore, a liquid crystal layer LC in the reflective display region 21 is driven in the vertical alignment mode.

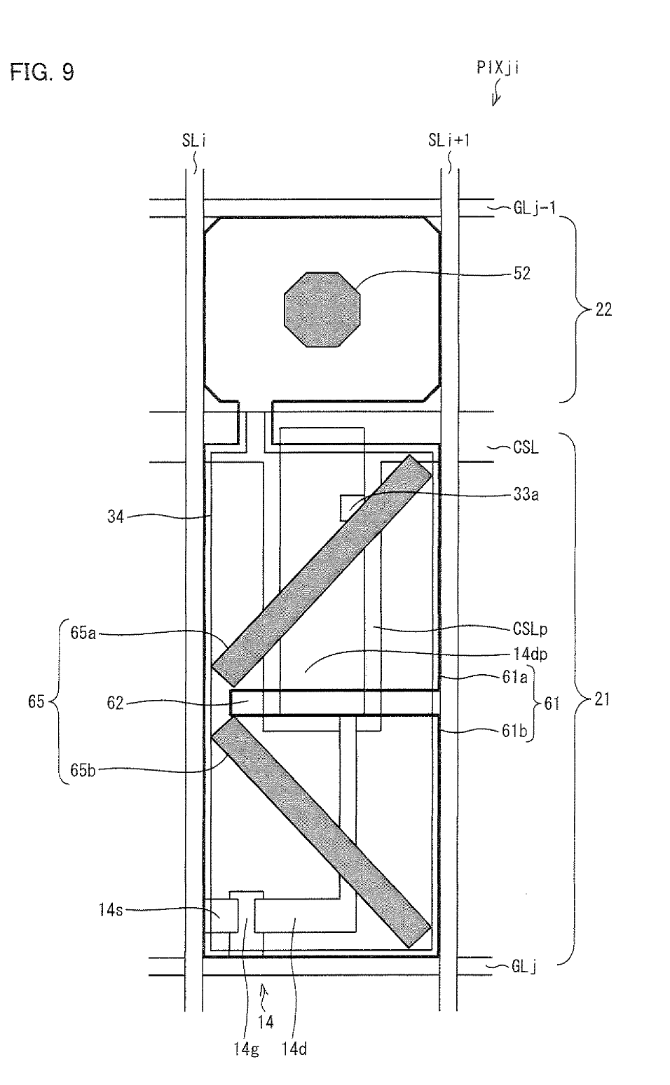

FIG. 9 is a plane view of a pixel PIXji which differs from the pixel PIX in FIG. 1 in that a pixel electrode 61 and a lib 65, instead of the pixel electrode 35 and the lib 51, are provided as alignment regulating protrusions.

The pixel electrode 61 has an area constituted of a region 61a and a region 61b connected with each other, each of which regions 61a and 61b has a substantially rectangular shape (in this case, a substantially square shape). The regions 61a and 61b are aligned along a direction in which a data signal line SLi is extended, wherein the region 61b is formed closer to a scanning signal line GLj. The regions 61a and 61b have end sections close to the data signal line GLj, respectively, which are connected with each other at a connection section, whereas the regions 61a and 61b are separated from each other via a gap 62 which does not constitute the connection section.

The lib 65 is constituted of a lib 65a and a lib 65b. The lib 65a is formed in one diagonal line of the region 61a (in this case, in a diagonal line extending from the connection section whereby the regions 61a and 61b are connected with each other). It is to be noted that the drawings is a simplified view of the pixel PIXji, and that the lib 65a is formed entirely in a region above the diagonal line. The lib 65a is a protrusion having a projecting-line shape, whose width is in a direction orthogonal to the diagonal line in the panel plane. The lib 65a has the same shape as the lib 51 and protrudes in the same direction as the lib 51.

The lib 65b is formed at and entirely along one diagonal line of the region 61b (in this case, in a diagonal line extending from the connection section whereby the regions 61a and 61b are connected with each other). It is to be noted that the drawing is the simplified view of the pixel PIXji, and that the lib 65b is formed entirely in a region above the diagonal line. The lib 65b is a protrusion having a projecting-line shape, whose width is in a direction orthogonal to the diagonal line in the panel plane. The lib 65b has the same shape as the lib 51 and protrudes in the same direction as the lib 51.

The diagonal line of the region 61a at and along which the lib 65a is formed is orthogonal to the diagonal line of the region 61b at and along which the lib 65b is formed. As such, these diagonal lines are extended in different directions. Therefore, the liquid crystal layer LC in the reflective display region 21 can be driven in the MVA mode. In this case, the gap 62 works as a slit for regulating alignment of liquid crystals. In the pixel PIXji, the diagonal line of the region 61a forms an angle of 45° with respect to both the scanning signal line GLj and the data signal line SLi, and the diagonal line of the region 61b forms an angle of 45° with respect to both the scanning signal line GLj and the data signal line SLi.

Use of the lib 53, 54, 55, 56, or 61 also makes it possible to increase a response speed in the reflective display region 21, from the same reason as in a case where the lib 51 is used. This can make a response characteristic of the reflective display closer to that of the transmissive display, as compared with the conventional technique.

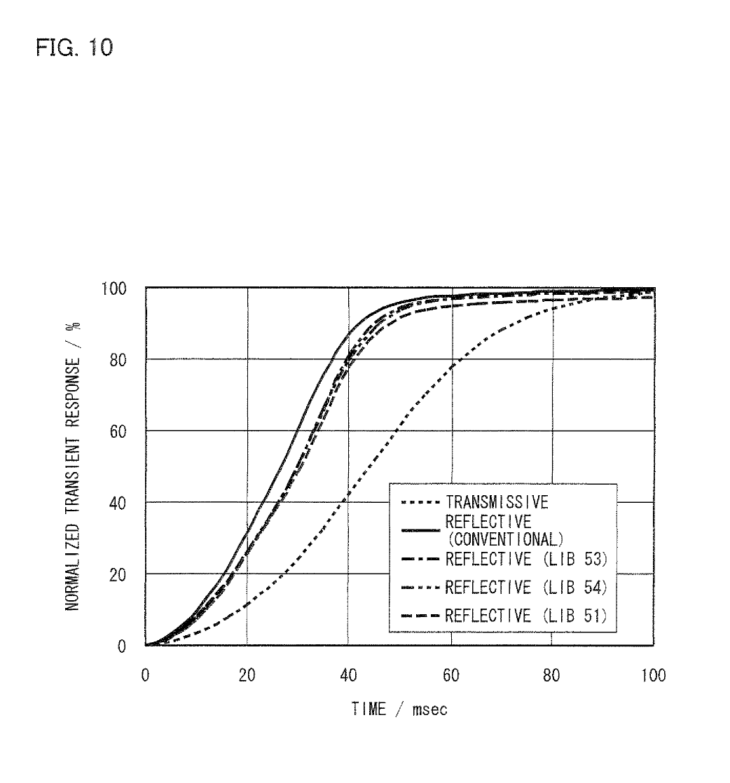

FIG. 10 shows a graph that shows response speeds of the reflective display which are obtained when the libs 51, 53, and 54 are used, respectively. The graph also shows a response speed of the transmissive display and that of conventional reflective display.

As compared with a curve (referred to as a curve a), a curve (referred to as a curve b) rises noticeably quickly, where the curve a shows the response speed of the transmissive display and the curve b shows that of the conventional reflective display. On the other hand, curves (referred to as curves c, d, and e, respectively) rise slower in this order so as to be closer to the curve a, where the curves c, d, and e show respective response speeds of the reflective display which are obtained when the libs 53, 54, and 51 are used.

Table 1 shows (1) the response speeds which are shown by the curves a through e in FIG. 10, respectively, and (ii) differences between the respective response speeds shown by the curves b through e and the response speed of the transmissive display (the response speed shown by the curve a). Each of the response speeds is defined by a rise time during which the individual curve reaches from 10% of a maximum value to 90% thereof (change in direction of black display to half-tone display).

TABLE 1

| | | Response time | |
|---|---|---|---|
| | | (from 10 to 90%)/ | Time Difference |
| | | msec | between Transmissive |
| | | Black to | display and Reflective |
| | | Half tone | display/msec |
| Transmissive | — | 53.7 | — |
| Reflective | Conventional | 32.3 | 21.4 |
| | Lib 53 | 32.8 | 20.9 (reduced by 2.4%) |
| | Lib 54 | 34.4 | 19.3 (reduced by 9.9%) |
| | Lib 51 | 37.1 | 16.7 (reduced by 22.1%) |

Table 1 shows that (i) when the lib 53 is used, the time difference between the response speed of the transmissive display and the response speed of the reflective display is reduced by 2.4%, (ii) when the lib 54 is used, the time difference between the response speed of the transmissive display and the response speed of the reflective display is reduced by 9.9%, and (iii) when the lib 51 is used, the time difference between the response speed of the transmissive display and the response speed of the reflective display is reduced by 22.1%.

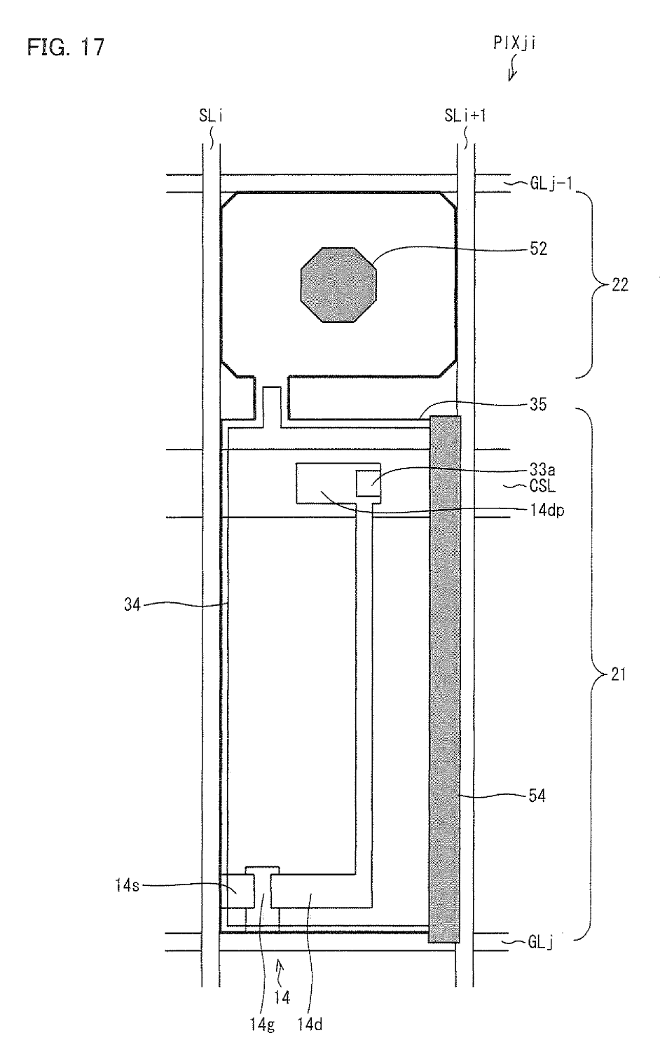

The pixel PIXji can be configured so that the storage capacitance line CSL is formed across the reflective display region 21, as shown in FIG. 17. In this case, the storage capacitance line CSL forms storage capacitance CSL, directly with a drain electrode pad 14dp routed to a region above the storage capacitance line CSL. This eliminates the need for the storage capacitance electrode pad CSLp being used in the configuration shown in FIG. 1. The configuration in FIG. 17 differs from that in FIG. 1 in this way, but a feature of the present invention, which is to be explained below, can be involved even in a different pixel configuration as shown in FIG. 17.

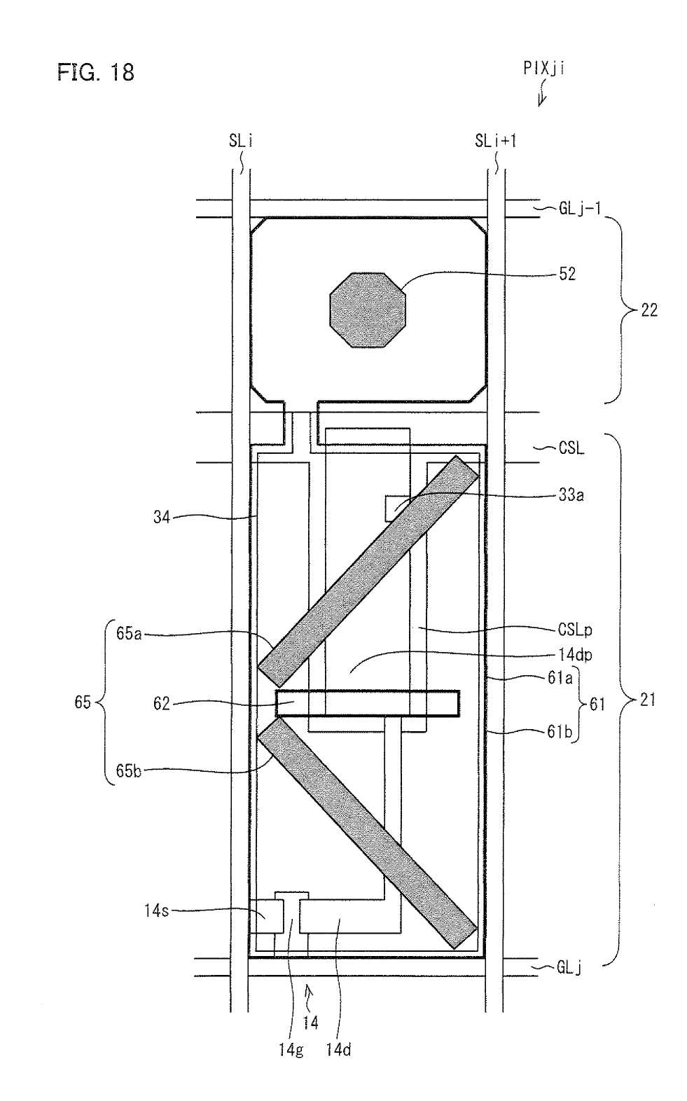

The following deals with a pixel PIXji differing from the pixel PIXji in FIG. 9 in that, as shown in FIG. 18, the regions 61a and 61b are also connected with each other via end sections formed close to the data signal line SLi+1. In the pixel PIXji, as described above, the regions 61a and 61b having substantially rectangular shapes are electrically connected with each other via plural parts. Even by such configuration, it is possible to attain an effect explained in the description of FIG. 9.

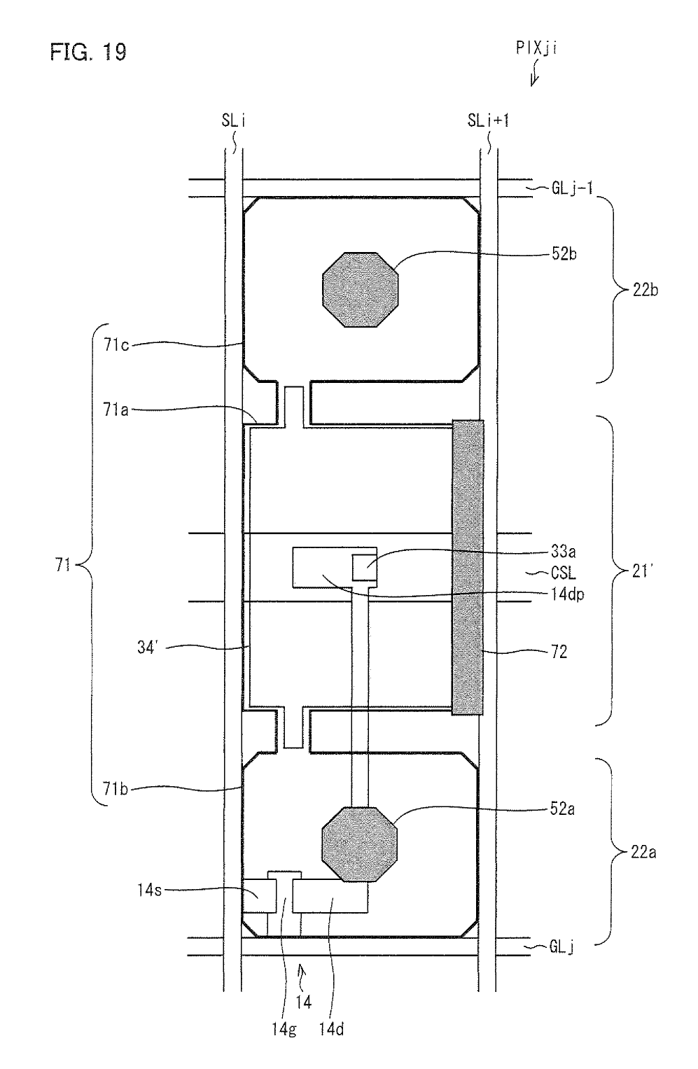

The pixel can be alternatively configured so that the transmissive display region is larger in area than the reflective display region. FIG. 19 shows, as one example, a configuration of the pixel PIXji having a reflective display region 21′, a first transmissive display region 22a, and a second transmissive display region 22b. The first transmissive display region 22a and the second transmissive display region 22b constitute a transmissive display region 22 in the pixel PIXji. The first transmissive display region 22a and the second transmissive display region 22b have areas, a total of which is greater than an area of the reflective display region 21′. The first transmissive display region 22a is formed close to the scanning signal line GLj in the pixel PIXji, whereas the second transmissive display region 22b is formed closed to the scanning signal line GLj-i in the pixel PIXji. The reflective transmissive display region 21′ is formed between the first transmissive display region 22a and the second transmissive display region 22b in the pixel PIXji. A storage capacitance line CSL is formed right below the reflective display region 21′, and this forms storage capacitance Cs in the same way as in FIG. 17.

The reflective display region 21′ has a pixel electrode part 71a, the first transmissive display region 22a has a pixel electrode part 71b, and the second transmissive display region 22b has a pixel electrode part 71c, which pixel electrode parts 71a through 71c constitute a pixel electrode 71. Each of the pixel electrode parts 71a through 71c has a substantially rectangular shape. The pixel electrode part 71b is connected with the pixel electrode part 71a at one side, and connected with the pixel electrode part 71c at the other side. The pixel electrode part 71a is formed so as to cover a reflective layer 34′.

In the reflective display region 21′, a lib 72 is formed. The lib 72 is formed at and entirely along that edge of the reflective display region 21′ which is close to the data signal line SLi+1. The lib 72 is a protrusion having a projecting-line shape, whose width is in a direction orthogonal to that edge of the reflective display region 21′ in the panel plane at and along which the lib 72 is provided. The lib 72 has the same shape as the lib 51 and protrudes in the same way as the lib 51. Therefore, a liquid crystal layer CL in the reflective display region 21′ is driven in the vertical alignment mode. In the first transmissive display region 22a, a lib 52a is formed, whereas in the second transmissive display region 22b, a lib 52b is formed. The libs 52a and 52b are the same alignment regulating protrusions as the rivet 52 described earlier.

The above descriptions explain the configurations of the liquid crystal display panel.

The lib 51, 53, 54, 55, 56, or 61 and the rivet 52 do not necessarily protrude from the counter substrate 12, but can alternatively protrude from the TFT substrate 11. That is, the lib 51, 53, 54, 55, 56, or 61 and the rivet 52 should be configured so as to protrude into the liquid crystal layer LC in a layer thickness direction of the liquid crystal layer.

In the description, the example is raised in which the liquid crystal layer is set thinner in the reflective display region 21 than in the transmissive display region 22 by using the layer thickness adjustment layer 43. However, the present invention is not limited to this. For adjustment of the display characteristics of the reflective display and the transmissive display, a liquid crystal layer having a combination of any layer thicknesses can be used.

The liquid crystal display device thus described hereinabove is further equipped with devices such as a peripheral circuitry, a backlight, and the like (the backlight can be included in the liquid crystal display panel) so as to constitute a liquid crystal display device.

The present invention is not limited to the description of the embodiment above, but may be altered by a skilled person within the scope of the claims. An embodiment based on a proper combination of technical means altered as appropriate within the scope of the claims is encompassed in the technical scope of the present invention.

As described so far, the liquid crystal display panel of the present invention is the liquid crystal display panel having the pixel regions each having the transmissive display region and the reflective display region, wherein: the reflective display region has the substantially rectangular shape when viewed in the direction orthogonal to the panel plane, and the liquid crystal display panel includes the protrusion formed at and entirely along at least one side of the shape, the protrusion having the projecting-line shape whose width is in the direction orthogonal to that edge of the reflective display region in the panel plane at and along which the protrusion is provided, and the protrusion protruding into the liquid crystal layer in the layer thickness direction of the liquid crystal layer.

This brings about an effect that realizes a transreflective liquid crystal display panel including an alignment regulating protrusion for driving a liquid crystal in the vertical alignment mode, in which liquid crystal display panel a response characteristic of reflective display can be made closer to that of transmissive display.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is suitably usable in a liquid crystal display device having a transmissive display region and a reflective display region.

1. A liquid crystal display panel having pixel regions each having a transmissive display region and a reflective display region, wherein:
the reflective display region has a substantially rectangular shape when viewed in a direction orthogonal to a panel plane; and
the liquid crystal display panel comprises:
a protrusion formed at and entirely along at least one edge of the reflective display region, the protrusion having a projecting-line shape whose width is in a direction orthogonal to that edge of the reflective display region in the panel plane at and along which the protrusion is provided, and the protrusion protruding into a liquid crystal layer in a layer thickness direction of the liquid crystal layer.

2. The liquid crystal display panel as set forth in claim 1, wherein:
the reflective display region has a substantially oblong shape; and
the protrusion is formed at and entirely along only one short edge or one long edge of the reflective display region.

3. The liquid crystal display panel as set forth in claim 1, wherein:
the reflective display region has a substantially oblong shape; and
the protrusion is formed at and entirely along one short edge and one long edge of the reflective display region.

4. A liquid crystal display panel having pixel regions each having a transmissive display region and a reflective display region, wherein:
the reflective display region has a substantially rectangular shape when viewed in a direction orthogonal to a panel plane; and
the liquid crystal display panel comprises:
a protrusion being extended orthogonally to and connecting, with each other, a pair of opposite two edges of the reflective display region in a panel plane, the protrusion having a projecting-line shape whose width is in a direction parallel with the pair of two opposite edges in the panel plane, and the protrusion protruding into a liquid crystal layer in a layer thickness direction of the liquid crystal layer.

5. The liquid crystal display panel as set forth in claim 4, wherein:
the reflective display region has a substantially oblong shape; and
the pair of opposite two edges are long edges.

6. The liquid crystal display panel as set forth in claim 4, wherein:
the protrusion bisects the region having the substantially rectangular shape when viewed in the direction orthogonal to the panel plane.

7. A liquid crystal display panel having pixel regions each having a transmissive display region and a reflective display region, wherein:
the reflective display region has a substantially rectangular shape when viewed in a direction orthogonal to a panel plane; and
the liquid crystal display panel comprises:
one protrusion formed at and entirely along one, diagonal line of the reflective display region, the protrusion having a projecting-line shape whose width is in a direction orthogonal to the one diagonal line in the panel plane, and the protrusion protruding into a liquid crystal layer in a layer thickness direction of the liquid crystal layer.

8. The liquid crystal display panel as set forth in claim 7, wherein:
the reflective display region has a substantially oblong shape.

9. A liquid crystal display panel having pixel regions each having a transmissive display region and a reflective display region, wherein:
the reflective display region consists of a plurality of regions connected with one another, each of which regions has a substantially rectangular shape; and
the liquid crystal display panel comprises:
one protrusion formed at and entirely along one diagonal line of the each of the plurality of the regions, the protrusion having a projecting-line shape whose width is in a direction orthogonal to the one diagonal line in the panel plane, and the protrusion protruding into a liquid crystal layer in a layer thickness direction of the liquid crystal layer.

10. The liquid crystal display panel as set forth in claim 9, wherein:
the plurality of the regions each having the substantially rectangular shape are two regions wherein the one diagonal line of one of the two region is extended in a different direction from that of the other of the two regions.

11. The liquid crystal display panel as set forth in claim 10, wherein:
each of the two regions has the one diagonal line, which forms an angle of 45° with both of a scanning signal line and a data signal line orthogonal to each other.

12. The liquid crystal display panel as set forth in claim 1, wherein:
in the transmissive display region of each pixel region, a protrusion having a projecting-dot shape when viewed in a direction orthogonal to the panel plane is formed, the protrusion protruding into the liquid crystal layer in the layer thickness direction of the liquid crystal layer.

13. The liquid crystal display panel as set forth in claim 1, wherein:
in each pixel region, (i) the reflective display region has a pixel electrode which is connected to a pixel electrode in the transmissive display region, and (ii) when viewed in a direction orthogonal to the panel plane, the protrusion having the projecting-line shape is formed in such a manner that the protrusion avoids a connection part via which the pixel electrode in the reflective display region is connected to the pixel electrode in the transmissive display region.

14. The liquid crystal display panel as set forth in claim 1, wherein:
in each pixel region, the reflective display region is larger in area than the transmissive display region when viewed in a direction orthogonal to the panel plane.

15. The liquid crystal display panel as set forth in claim 1, wherein:
the liquid crystal layer is thicker in the reflective display region than in the transmissive display region.

16. A liquid crystal display device, comprising a liquid crystal display panel as set forth in claim 1.
